(19) United States
(12) Patent Application Publication
(10) Pub. No.: US 2026/0179003 A1
(43) Pub. Date: Jun. 25, 2026

(54) WORK SUPPORT DEVICE, WORK SUPPORT METHOD, AND WORK SUPPORT SYSTEM

(71) Applicant: Mitsubishi Electric Corporation, Tokyo (JP)

(72) Inventors: Asako AKIYAMA, Tokyo (JP); Atsuki TACHIBANA, Tokyo (JP); Shinichi KATO, Tokyo (JP); So SATOH, Tokyo (JP); Kae OHASHI, Tokyo (JP); Yuka HIRAI, Tokyo (JP)

(73) Assignee: Mitsubishi Electric Corporation, Tokyo (JP)

(21) Appl. No.: 19/542,710

(22) Filed: Feb. 18, 2026

Related U.S. Application Data
(63) Continuation of application No. PCT/JP2023/036943, filed on Oct. 12, 2023.

(51) Int. Cl. G06Q 10/0631; G06T 19/00

(52) U.S. Cl. CPC G06Q 10/063114; G06T 19/006

(57) ABSTRACT

A work support device includes: a sensing data acquisition unit to acquire sensing data representing an implementation status of work performed by an operator from a sensor to monitor the implementation status of the work; an AR content generation unit to generate AR content corresponding to the implementation status of the work on the basis of the sensing data acquired by the sensing data acquisition unit; and a display data output unit to output display data representing the AR content generated by the AR content generation unit.

### CROSS-REFERENCE TO RELATED APPLICATION

This application is a continuation application of International Application PCT/JP2023/036943, filed on Oct. 12, 2023, and designating the U.S., the entire contents of which are incorporated herein by reference.

### TECHNICAL FIELD

The present disclosure relates to a work support device, a work support method, and a work support system.

### BACKGROUND ART

There are work support devices to support work performed by an operator.

As such a work support device, for example, Patent Literature 1 discloses a fork positioning support device including a camera and an image display unit.

The camera captures an image of the front space of a forklift and outputs, to the image display unit, image data representing the image of the front space. The front image-capturing area of the camera is an area including a pallet conveyed by the forklift and the fork of the forklift. The image display unit causes a display to display the image represented by the image data output from the camera.

### CITATION LIST

### Patent Literatures

Patent Literature 1: JP-2013-86959-A

### SUMMARY OF INVENTION

### Technical Problem

There is a problem with the fork positioning support device disclosed in Patent Literature 1 that, although an operator who operates the forklift can check relative positions of the pallet and the fork by viewing the display, the operator cannot check how much pallet conveyance work has progressed, as the implementation status of the pallet conveyance work.

The present disclosure has been made to solve the problem described above, and an object thereof is to obtain a work support device to allow an operator to check the implementation status of work.

### Solution to Problem

A work support device according to the present disclosure includes processing circuitry to acquire sensing data representing an implementation status of work performed by an operator from a sensor to monitor the implementation status of the work, to generate AR content corresponding to the implementation status of the work on a basis of the sensing data acquired by the processing circuitry, to output display data representing the AR content generated by the processing circuitry, and to calculate an achievement rate of the work performed by the operator as the implementation status of the work on a basis of the sensing data acquired by the processing circuitry and generates the AR content corresponding to both a current season and the achievement rate of the work.

### Advantageous Effects of Invention

The present disclosure allows an operator to check the implementation status of work.

### BRIEF DESCRIPTION OF DRAWINGS

FIG. 1 is a configuration diagram illustrating a work support system including a work support device 2 according to a first embodiment.

FIG. 2 is a hardware configuration diagram illustrating the hardware of the work support device 2 according to the first embodiment.

FIG. 3 is a hardware configuration diagram of a computer in a case where the work support device 2 is implemented by software, firmware, or the like.

FIG. 4 is a flowchart illustrating a work support method which is a processing procedure performed by the work support device 2.

FIG. 5 is an explanatory diagram illustrating products conveyed by a conveyor belt.

FIG. 6 is an explanatory diagram illustrating an example of AR content corresponding to a work achievement rate Acr.

FIG. 7 is an explanatory diagram illustrating an example of the AR content corresponding to the work achievement rate Acr.

FIG. 8 is an explanatory diagram illustrating an example of the AR content corresponding to the work achievement rate Acr.

FIG. 9 is an explanatory diagram illustrating an example of the AR content corresponding to the work achievement rate Acr.

FIG. 10 is an explanatory diagram illustrating an example of AR content representing that the current time is within working hours.

FIG. 11 is an explanatory diagram illustrating an example of AR content representing that the current time is within a break period.

FIG. 12 is an explanatory diagram illustrating AR content evocative of summer as an example of AR content corresponding to the current season.

FIG. 13 is an explanatory diagram illustrating an example of AR content corresponding to the implementation time of work.

FIG. 14 is an explanatory diagram illustrating an example of AR content corresponding to the current weather.

FIG. 15 is a configuration diagram illustrating a work support system including a work support device 2 according to a sixth embodiment.

FIG. 16 is a hardware configuration diagram illustrating the hardware of the work support device 2 according to the sixth embodiment.

FIG. 17 is an explanatory diagram illustrating an example of AR content representing that garbage has accumulated.

FIG. 18 is a configuration diagram illustrating a work support system including a work support device 2 according to a seventh embodiment.

FIG. 19 is a hardware configuration diagram illustrating the hardware of the work support device 2 according to the seventh embodiment.

FIG. 20 is an explanatory diagram illustrating an example of AR content representing a mascot character who guides the implementation content of work.

FIG. 21 is a configuration diagram illustrating a work support system including a work support device 2 according to an eighth embodiment.

FIG. 22 is a hardware configuration diagram representing the hardware of the work support device 2 according to the eighth embodiment.

FIG. 23 is an explanatory diagram illustrating an example of AR content representing operations performed by a skilled worker.

### DESCRIPTION OF EMBODIMENTS

Hereinbelow, modes for implementing the present disclosure are explained with reference to the attached drawings in order to explain the present disclosure in more detail.

### First Embodiment

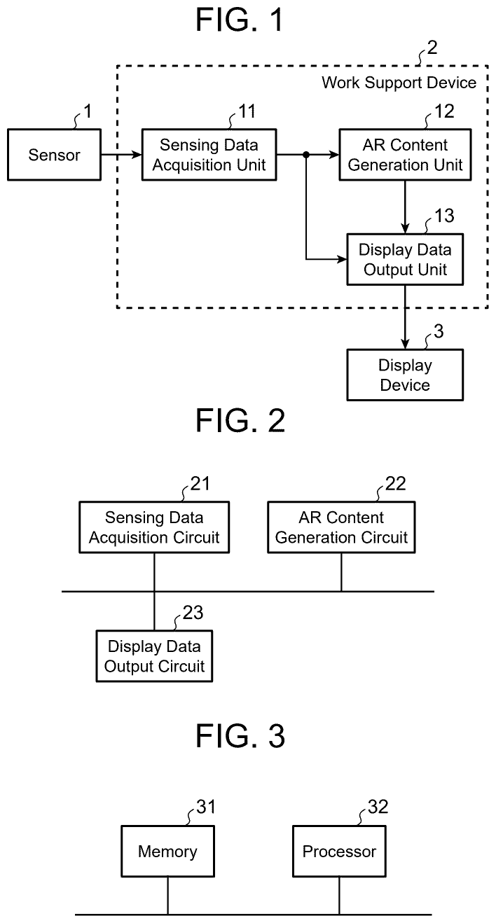

FIG. 1 is a configuration diagram illustrating a work support system including a work support device 2 according to a first embodiment.

FIG. 2 is a hardware configuration diagram illustrating the hardware of the work support device 2 according to the first embodiment.

The work support system illustrated in FIG. 1 includes a sensor 1, the work support device 2, and a display device 3.

For example, the sensor 1 is implemented by a camera or a lidar device.

The sensor 1 monitors the implementation status of work performed by an operator and outputs, to the work support device 2, sensing data representing the implementation status of the work.

Each of the camera and the lidar device is an image-capturing sensor that captures an image of the implementation status of the work. In particular, the lidar device is an device that is capable of emitting laser light toward a target object, receiving reflection light of the laser light by the target object, and detecting the shape of the target object on the basis of the reflection light.

For example, the work performed by the operator includes: work of receiving products conveyed by a conveyor belt; work of sorting products conveyed by a conveyor belt; work of assembling products; work of assembling products by operating a robot; work of determining whether or not the quality of products is good; work of determining whether or not the quality of products is good by operating a robot; and work of conveying pallets by operating a forklift.

For example, the implementation status of the work include: an achievement rate of the work performed by the operator; the number of times of achievement of the work performed by the operator; the number of days of implementation of the work performed by the operator; the progress status of the work performed by the operator; and the accuracy of the work performed by the operator.

For example, when the work performed by the operator is work of receiving products, for example, examples of an achievement rate of the work include the proportion of the number of products received until the current time point to the target number of products received. In addition, for example, examples of the number of times of achievement of the work include the number of products received until the current time point.

For example, when the work performed by the operator is work of conveying pallets, for example, examples of an achievement rate of the work include the proportion of the number of pallets conveyed until the current time point to the target number of pallets conveyed. In addition, for example, examples of the number of times of achievement of the work include the number of pallets conveyed until the current time point.

For example, when the work performed by the operator is work of assembling products, for example, examples of the progress status of the work include one representing work elements having been implemented among a plurality of work elements that are required from the start of assembly of the products until the completion of the products.

The work support device 2 includes a sensing data acquisition unit 11, an AR content generation unit 12, and a display data output unit 13.

The work support device 2 generates Augmented Reality (AR) content corresponding to the implementation status of the work and outputs display data representing the AR content to the display device 3.

For example, the display device 3 is implemented by AR glasses, a tablet, or a smartphone.

The display device 3 displays the AR content on the basis of the display data output from the work support device 2.

For example, the sensing data acquisition unit 11 is implemented by a sensing data acquisition circuit 21 illustrated in FIG. 2.

The sensing data acquisition unit 11 acquires sensing data representing the implementation status of the work from the sensor 1. When the sensor 1 is an image-capturing sensor that captures an image of the implementation status of the work, as the sensing data representing the implementation status of the work, the sensing data acquisition unit 11 acquires captured-image data representing an image-capturing result of the image-capturing sensor.

The sensing data acquisition unit 11 outputs the sensing data to each of the AR content generation unit 12 and the display data output unit 13.

For example, the AR content generation unit 12 is implemented by an AR content generation circuit 22 illustrated in FIG. 2.

The AR content generation unit 12 acquires the sensing data from the sensing data acquisition unit 11.

On the basis of the sensing data, the AR content generation unit 12 generates the AR content corresponding to the implementation status of the work.

The AR content generation unit 12 outputs the display data representing the AR content to the display data output unit 13.

For example, the display data output unit 13 is implemented by a display data output circuit 23 illustrated in FIG. 2.

The display data output unit 13 acquires the sensing data from the sensing data acquisition unit 11 and acquires the display data representing the AR content from the AR content generation unit 12.

For example, when the display device 3 is AR glasses, and the operator wearing the AR glasses can view the implementation status of the work through the AR glasses with her/his naked eyes, the display data output unit 13 acquires only the display data representing the AR content and outputs the display data to the display device 3.

When the operator wearing the AR glasses cannot view the implementation status of the work through the AR glasses with her/his naked eyes, the display data output unit 13 acquires both the display data representing the AR content and the sensing data.

For example, in a case where the display device 3 is a tablet or a smartphone also, the display data output unit 13 acquires both the display data representing the AR content and the sensing data.

The display data output unit 13 overlays the display data representing the AR content on the captured-image data, which is the sensing data, and outputs the captured-image data after the overlay of the display data to the display device 3.

It is assumed in FIG. 1 that each of the sensing data acquisition unit 11, the AR content generation unit 12, and the display data output unit 13, which are constituent elements of the work support device 2, is implemented by dedicated hardware illustrated in FIG. 2. That is, it is assumed that the work support device 2 is implemented by the sensing data acquisition circuit 21, the AR content generation circuit 22, and the display data output circuit 23.

For example, each of the sensing data acquisition circuit 21, the AR content generation circuit 22, and the display data output circuit 23 corresponds to a single circuit, a composite circuit, a programmed processor, a parallel-programmed processor, an Application Specific Integrated Circuit (ASIC), a Field-Programmable Gate Array (FPGA), or a combination of these.

The constituent elements of the work support device 2 are not limited to those implemented by dedicated hardware, but the work support device 2 may be implemented by software, firmware, or a combination of software and firmware.

The software or the firmware is stored as programs in a memory of a computer. The computer means hardware to execute programs, and, for example, corresponds to a Central Processing Unit (CPU), a Graphics Processing Unit (GPU), a central processor, a processing device, an arithmetic operation device, a microprocessor, a microcomputer, a processor, or a Digital Signal Processor (DSP).

FIG. 3 is a hardware configuration diagram of the computer in a case where the work support device 2 is implemented by software, firmware, or the like.

In a case where the work support device 2 is implemented by software, firmware, or the like, a program for causing the computer to execute a processing procedure performed at each of the sensing data acquisition unit 11, the AR content generation unit 12, and the display data output unit 13 is stored in a memory 31. Then, a processor 32 of the computer executes the programs stored in the memory 31.

In addition, FIG. 2 illustrates an example in which each of the constituent elements of the work support device 2 is implemented by dedicated hardware, and FIG. 3 illustrates an example in which the work support device 2 is implemented by software, firmware, or the like. However, this is merely an example. Some constituent elements of the work support device 2 may be implemented by dedicated hardware, and the remaining constituent elements may be implemented by software, firmware, or the like.

Next, operations performed by the work support system illustrated in FIG. 1 are explained.

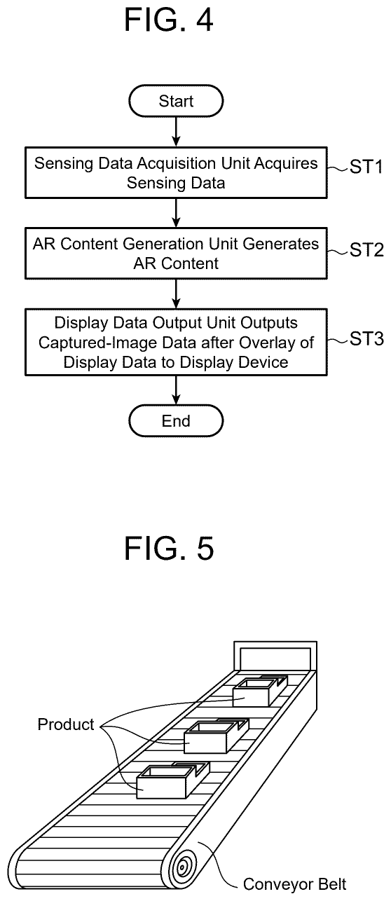

FIG. 4 is a flowchart illustrating a work support method which is a processing procedure performed by the work support device 2.

For example, the sensor 1 is installed on a helmet worn by the operator, AR glasses worn by the operator, the wall/ceiling of a factory which is a facility where the work is being performed, or the like.

The sensor 1 monitors the implementation status of the work performed by an operator and outputs, to the work support device 2, the sensing data representing the implementation status of the work.

FIG. 5 is an explanatory diagram illustrating products conveyed by a conveyor belt.

Hereinbelow, an example in which the work performed by the operator is work of receiving products conveyed by the conveyor belt is explained.

Although the operator is not illustrated in FIG. 5, it is assumed that, for example, the operator is standing at the side of the conveyor belt or near the leading end of the conveyor belt.

The sensing data acquisition unit 11 acquires the sensing data representing the implementation status of the work from the sensor 1 (Step ST1 in FIG. 4).

Here, for convenience of explanation, it is assumed that the sensor 1 is an image-capturing sensor to capture an image of the implementation status of the work, and, as the sensing data representing the implementation status of the work, the sensing data acquisition unit 11 acquires captured-image data representing an image-capturing result of the image-capturing sensor.

The sensing data acquisition unit 11 outputs the sensing data to each of the AR content generation unit 12 and the display data output unit 13.

The AR content generation unit 12 acquires the sensing data from the sensing data acquisition unit 11.

On the basis of the sensing data, the AR content generation unit 12 generates the AR content corresponding to the implementation status of the work (Step ST2 in FIG. 4).

The AR content generation unit 12 outputs the display data representing the AR content to the display data output unit 13.

Hereinbelow, an AR content generation process performed by the AR content generation unit 12 is explained specifically.

On the basis of the sensing data, the AR content generation unit 12 counts the number of products that are conveyed by the conveyor belt and received by the operator. Since the process of counting the number of products received by the operator on the basis of the captured-image data, which is the sensing data, itself is a known technology, and detailed explanation thereof is omitted.

Assuming that the target number of products received is Enum, and the number of products received by the operator is Tnum, the AR content generation unit 12 calculates a work achievement rate Acr as represented by the following Formula (1).

Acr=(Tnum/Enum)×100%

As the AR content corresponding to the implementation status of the work, the AR content generation unit 12 generates AR content corresponding to the work achievement rate Acr. Since the AR content generation process itself is a known technology, detailed explanation thereof is omitted.

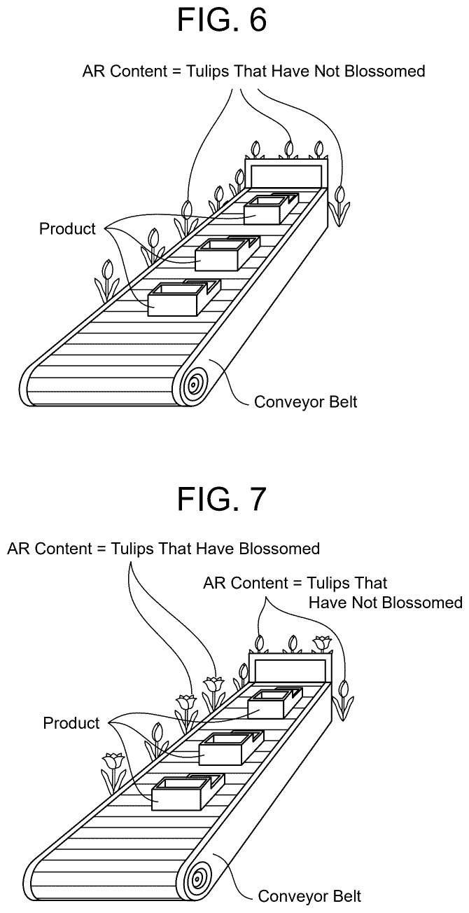

Each of FIGS. 6, 7, and 8 is an explanatory diagram illustrating an example of the AR content corresponding to the work achievement rate Acr.

Each of FIGS. 6, 7, and 8 illustrates an example in which the AR content corresponding to the work achievement rate Acr is tulips. Here, as the work achievement rate Acr increases, the number of tulip blossoms increases.

FIG. 6 illustrates an example in which tulips have not blossomed at all since the work achievement rate Acr is low.

FIG. 7 illustrates an example in which tulips have bloomed blossoms a little since the work achievement rate Acr has increased a little.

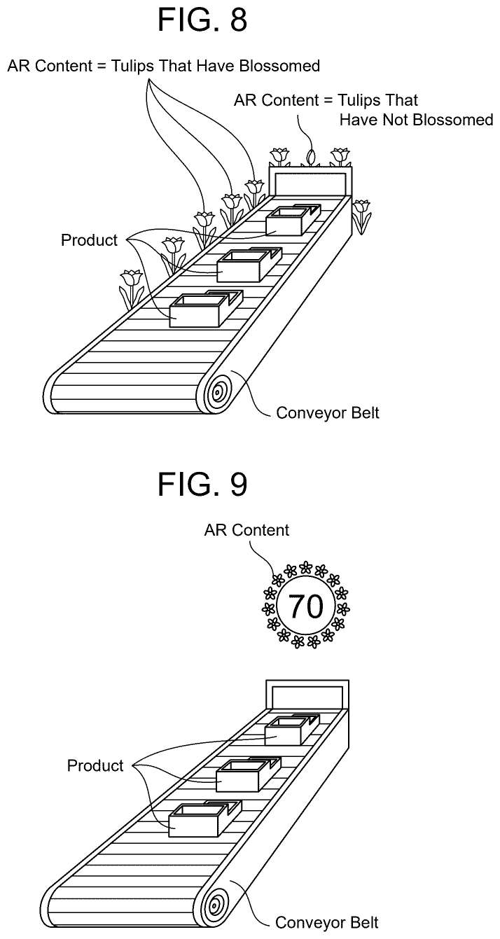

FIG. 8 illustrates an example in which tulips have bloomed nearly fully since the work achievement rate Acr has approached 100%.

Here, the AR content corresponding to the implementation status of the work represents tulips whose degree of blooming changes depending on the achievement rate Acr. However, this is merely an example. As the AR content corresponding to the implementation status of the work, for example, the AR content generation unit 12 may generate the AR content representing the work achievement rate Acr as illustrated in FIG. 9.

FIG. 9 is an explanatory diagram illustrating an example of the AR content corresponding to the work achievement rate Acr.

As the AR content corresponding to the work achievement rate Acr, FIG. 9 illustrates AR content in which a numeral representing the achievement rate Acr is surrounded by flowers.

The display data output unit 13 acquires the sensing data from the sensing data acquisition unit 11 and acquires the display data representing the AR content from the AR content generation unit 12.

The display data output unit 13 overlays the display data representing the AR content on the captured-image data, which is the sensing data.

When overlaying the display data on the captured-image data, the display data output unit 13 overlays the display data on the captured-image data in such a manner that the implementation status of the work performed by the operator is not hidden by the AR content.

That is, as illustrated in FIGS. 6 to 9, the display data output unit 13 overlays the display data on the captured-image data in such a manner that products being conveyed by the conveyor belt are not hidden by the AR content.

The display data output unit 13 outputs the captured-image data after the overlay of the display data to the display device 3 (Step ST3 in FIG. 4).

The display device 3 acquires the captured-image data after the overlay of the display data from the display data output unit 13 of the work support device 2.

The display device 3 displays the AR content on the basis of the captured-image data after the overlay of the display data.

Thereby, for example, the AR content illustrated in any one of FIGS. 6 to 9 is displayed on the display device 3.

In the first embodiment mentioned above, the work support device 2 includes: the sensing data acquisition unit 11 to acquire the sensing data representing the implementation status of the work from the sensor 1 to monitor the implementation status of the work performed by the operator; the AR content generation unit 12 to generate the AR content corresponding to the implementation status of the work on the basis of the sensing data acquired by the sensing data acquisition unit 11; and the display data output unit 13 to output the display data representing the AR content generated by the AR content generation unit 12. Accordingly, the work support device 2 allows the operator to check the implementation status of the work.

Note that, by displaying the AR content corresponding to the implementation status of the work, it is possible also to achieve the advantageous effect that concentration of the operator is maintained, the advantageous effect that motivation of the operator is enhanced, or the advantageous effect that refreshment of the operator is promoted.

In addition, in the first embodiment, the work support device 2 is configured in such a manner that, on the basis of the sensing data acquired by the sensing data acquisition unit 11, the AR content generation unit 12 calculates the achievement rate of the work performed by the operator as the implementation status of the work and generates the AR content corresponding to the achievement rate of the work. Accordingly, the work support device 2 allows the operator to check the achievement rate of the work.

In the work support device 2 illustrated in FIG. 1, as the AR content corresponding to the implementation status of the work, the AR content generation unit 12 generates tulips whose degree of blooming changes depending on the work achievement rate Acr. However, this is merely an example. The AR content generation unit 12 may accept selection of to-be-generated AR content before generating the AR content corresponding to the implementation status of the work.

Specifically, for example, the AR content generation unit 12 includes a user interface, and, when a user operates the user interface to thereby select, for example, tulips whose degree of blooming changes depending on the work achievement rate Acr as illustrated in FIGS. 6 to 8 as the to-be-generated AR content, the AR content generation unit 12 generates tulips whose degree of blooming changes depending on the work achievement rate Acr.

When the user operates the user interface to thereby select, for example, the AR content in which a numeral representing the achievement rate Acr is surrounded by flowers as illustrated in FIG. 9 as the to-be-generated AR content, the AR content generation unit 12 generates the AR content in which a numeral representing the achievement rate Acr is surrounded by flowers.

In addition, the AR content generation unit 12 may acquire the current season from any one of a built-in calendar or an external calendar and switch the AR content corresponding to the implementation status of the work depending on the current season.

When the current season is spring, as illustrated in FIGS. 6 to 8, the AR content generation unit 12 generates, for example, tulips whose degree of blooming changes depending on the work achievement rate Acr as the AR content corresponding to the implementation status of the work.

When the current season is summer, the AR content generation unit 12 generates, for example, cherry blossoms whose degree of blooming changes depending on the work achievement rate Acr as the AR content corresponding to the implementation status of the work.

When the current season is autumn, the AR content generation unit 12 generates, for example, autumn leaves whose coloration changes depending on the work achievement rate Acr as the AR content corresponding to the implementation status of the work.

When the current season is winter, the AR content generation unit 12 generates, for example, snowfall whose amount of accumulation changes depending on the work achievement rate Acr as the AR content corresponding to the implementation status of the work.

In the work support device 2 illustrated in FIG. 1, as the AR content corresponding to the implementation status of the work, the AR content generation unit 12 generates the AR content corresponding to the work achievement rate Acr. However, this is merely an example. As the AR content corresponding to the implementation status of the work, for example, the AR content generation unit 12 may generate AR content corresponding to any one of: the number of times of achievement of the work performed by the operator; the number of days of implementation of the work performed by the operator; the progress status of the work performed by the operator; or the accuracy of the work performed by the operator.

In a case where the AR content corresponding to the progress status of the work is generated, the AR content generation unit 12 can recognize the progress status of the work by counting work elements having been implemented among a plurality of work elements that are required from the start of assembly of products until the completion of the products.

In the work support device 2 illustrated in FIG. 1, the AR content generation unit 12 generates the AR content corresponding to the implementation status of the work. The AR content generation unit 12 may generate the AR content corresponding to the implementation status of the work and additionally generate AR content representing an ideal standing position of the operator. For example, information representing the ideal standing position of the operator is stored in an internal memory of the AR content generation unit 12. For example, examples of the AR content representing the ideal standing position of the operator include an illustration of footprints representing the ideal standing position of the operator.

### Second Embodiment

In a work support device 2 explained in a second embodiment, an AR content generation unit 12 generates AR content corresponding to the implementation status of work and additionally generates AR content corresponding to the current time.

The configuration of the work support device 2 according to the second embodiment is similar to the configuration of the work support device 2 according to the first embodiment, and the configuration diagram illustrating a work support system including the work support device 2 according to the second embodiment is FIG. 1.

The AR content generation unit 12 generates the AR content corresponding to the implementation status of the work and additionally generates the AR content corresponding to the current time.

The AR content generation unit 12 outputs, to a display data output unit 13, display data representing the AR content corresponding to the implementation status of the work and display data representing the AR content corresponding to the current time.

Next, operations performed by the work support system according to the second embodiment are explained. It should be noted that the work support system according to the second embodiment is similar to the work support system illustrated in FIG. 1 except for the AR content generation unit 12. Because of this, here, operations performed by the AR content generation unit 12 are mainly explained.

The AR content generation unit 12 acquires sensing data from a sensing data acquisition unit 11.

Similarly to the first embodiment, on the basis of the sensing data, the AR content generation unit 12 generates the AR content corresponding to the implementation status of the work.

The AR content generation unit 12 acquires the current time from any one of a built-in clock or an external clock.

The AR content generation unit 12 generates the AR content corresponding to the current time.

Hereinbelow, a process performed by the AR content generation unit 12 to generate the AR content corresponding to the current time is explained specifically.

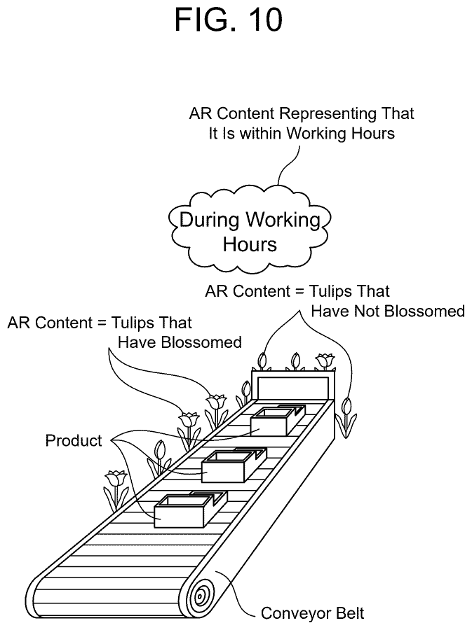

For example, when the current time is a time within working hours, for example, as illustrated in FIG. 10, the AR content generation unit 12 generates AR content representing that it is within the working hours.

FIG. 10 is an explanatory diagram illustrating an example of the AR content representing that the current time is within the working hours.

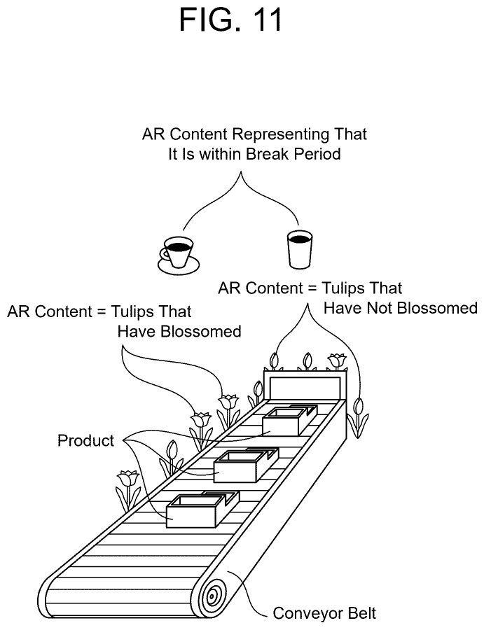

For example, when the current time is a time within a break period, for example, as illustrated in FIG. 11, the AR content generation unit 12 generates AR content representing that it is within the break period.

FIG. 11 is an explanatory diagram illustrating an example of the AR content representing that the current time is within the break period.

In FIG. 11, each of a coffee cup and a tea bowl is AR content representing that it is within the break period.

Here, as the AR content corresponding to the current time, the AR content generation unit 12 generates any one of the AR content representing that it is within the working hours or the AR content representing that it is within the break period. However, this is merely an example. As the AR content corresponding to the current time, for example, the AR content generation unit 12 may generate any one of AR content representing that it is morning, AR content representing that it is daytime, or AR content representing that it is nighttime.

The display data output unit 13 acquires the sensing data from the sensing data acquisition unit 11.

In addition, the display data output unit 13 acquires, from the AR content generation unit 12, each of the AR content corresponding to the implementation status of the work and the AR content corresponding to the current time.

The display data output unit 13 overlays the display data representing each of the types of AR content on the captured-image data, which is the sensing data.

When overlaying the display data on the captured-image data, the display data output unit 13 overlays the display data on the captured-image data in such a manner that the implementation status of the work performed by an operator is not hidden by each of the types of AR content.

That is, as illustrated in FIGS. 10 to 11, the display data output unit 13 overlays the display data on the captured-image data in such a manner that products being conveyed by the conveyor belt are not hidden by the AR content.

The display data output unit 13 outputs the captured-image data after the overlay of the display data to a display device 3.

The display device 3 acquires the captured-image data after the overlay of the display data from the display data output unit 13 of the work support device 2.

The display device 3 displays the AR content on the basis of the captured-image data after the overlay of the display data.

Thereby, for example, the AR content illustrated in any one of FIG. 10 or 11 is displayed on the display device 3.

In the second embodiment mentioned above, the work support device 2 is configured in such a manner that the AR content generation unit 12 generates the AR content corresponding to the implementation status of the work and additionally generates the AR content corresponding to the current time. Accordingly, the work support device 2 allows the operator to check the implementation status of the work and additionally allows the operator to check the time period to which the current time belongs.

### Third Embodiment

In a work support device 2 explained in a third embodiment, an AR content generation unit 12 generates AR content corresponding to the implementation status of work and additionally generates AR content corresponding to the current season.

The configuration of the work support device 2 according to the third embodiment is similar to the configuration of the work support device 2 according to the first embodiment, and the configuration diagram illustrating a work support system including the work support device 2 according to the third embodiment is FIG. 1.

The AR content generation unit 12 generates the AR content corresponding to the implementation status of the work and additionally generates the AR content corresponding to the current season.

The AR content generation unit 12 outputs, to a display data output unit 13, display data representing the AR content corresponding to the implementation status of the work and display data representing the AR content corresponding to the current season.

Next, operations performed by the work support system according to the third embodiment are explained. It should be noted that the work support system according to the third embodiment is similar to the work support system illustrated in FIG. 1 except for the AR content generation unit 12. Because of this, here, operations performed by the AR content generation unit 12 are mainly explained.

The AR content generation unit 12 acquires sensing data from a sensing data acquisition unit 11.

Similarly to the first embodiment, on the basis of the sensing data, the AR content generation unit 12 generates the AR content corresponding to the implementation status of the work.

The AR content generation unit 12 acquires the current season from any one of a built-in calendar or an external calendar.

The AR content generation unit 12 generates the AR content corresponding to the current season.

Hereinbelow, a process performed by the AR content generation unit 12 to generate the AR content corresponding to the current season is explained specifically.

When the current season is spring, the AR content generation unit 12 generates AR content evocative of spring. For example, examples of the AR content evocative of spring include AR content representing cherry blossoms, AR content representing plum blossoms, and AR content representing bamboo shoots.

When the current season is summer, the AR content generation unit 12 generates AR content evocative of summer. For example, examples of the AR content evocative of summer include AR content representing watermelon, AR content representing fireworks, and AR content representing a bathing beach.

When the current season is autumn, the AR content generation unit 12 generates AR content evocative of autumn. For example, examples of the AR content evocative of autumn include AR content representing autumn leaves, AR content representing chestnuts, and AR content representing Pacific saury.

When the current season is winter, the AR content generation unit 12 generates AR content evocative of winter. For example, examples of the AR content evocative of winter include AR content representing a snowman, AR content representing skiing, and AR content representing a muffler.

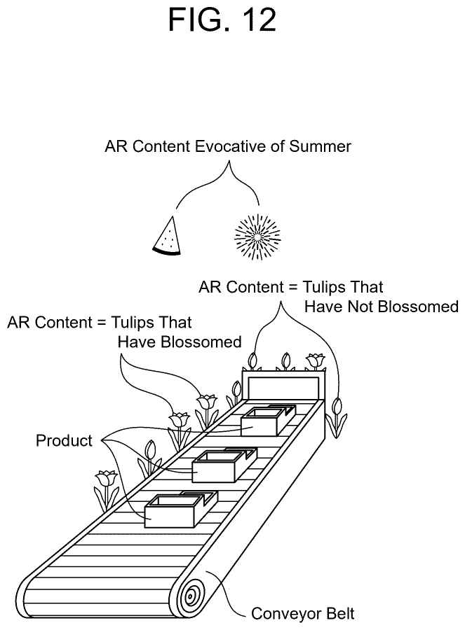

FIG. 12 is an explanatory diagram illustrating the AR content evocative of summer as an example of the AR content corresponding to the current season.

Here, as the AR content corresponding to the current season, the AR content generation unit 12 generates any one of the AR content evocative of spring, the AR content evocative of summer, the AR content evocative of autumn, or the AR content evocative of winter. However, this is merely an example. As the AR content corresponding to the current season, for example, the AR content generation unit 12 may generate AR content evocative of each month from January until December.

The display data output unit 13 acquires the sensing data from the sensing data acquisition unit 11.

In addition, the display data output unit 13 acquires, from the AR content generation unit 12, each of the AR content corresponding to the implementation status of the work and the AR content corresponding to the current season.

The display data output unit 13 overlays the display data representing each of the types of AR content on the captured-image data, which is the sensing data.

When overlaying the display data on the captured-image data, the display data output unit 13 overlays the display data on the captured-image data in such a manner that the implementation status of the work performed by an operator is not hidden by each of the types of AR content.

That is, as illustrated in FIG. 12, the display data output unit 13 overlays the display data on the captured-image data in such a manner that products being conveyed by the conveyor belt are not hidden by the AR content.

The display data output unit 13 outputs the captured-image data after the overlay of the display data to a display device 3.

The display device 3 acquires the captured-image data after the overlay of the display data from the display data output unit 13 of the work support device 2.

The display device 3 displays the AR content on the basis of the captured-image data after the overlay of the display data.

Thereby, for example, the AR content illustrated in FIG. 12 is displayed on the display device 3.

In the third embodiment mentioned above, the work support device 2 is configured in such a manner that the AR content generation unit 12 generates the AR content corresponding to the implementation status of the work and additionally generates the AR content corresponding to the current season. Accordingly, the work support device 2 allows the operator to check the implementation status of the work and additionally allows the operator to check the current season.

### Fourth Embodiment

In a work support device 2 explained in a fourth embodiment, an AR content generation unit 12 generates AR content corresponding to the implementation status of work and additionally generates AR content corresponding to the implementation time of the work.

The configuration of the work support device 2 according to the fourth embodiment is similar to the configuration of the work support device 2 according to the first embodiment, and the configuration diagram illustrating a work support system including the work support device 2 according to the fourth embodiment is FIG. 1.

The AR content generation unit 12 generates the AR content corresponding to the implementation status of the work and additionally generates the AR content corresponding to the implementation time of the work.

The AR content generation unit 12 outputs, to a display data output unit 13, display data representing the AR content corresponding to the implementation status of the work and display data representing the AR content corresponding to the implementation time of the work.

Next, operations performed by the work support system according to the fourth embodiment are explained. It should be noted that the work support system according to the fourth embodiment is similar to the work support system illustrated in FIG. 1 except for the AR content generation unit 12. Because of this, here, operations performed by the AR content generation unit 12 are mainly explained.

The AR content generation unit 12 acquires sensing data from a sensing data acquisition unit 11.

Similarly to the first embodiment, on the basis of the sensing data, the AR content generation unit 12 generates the AR content corresponding to the implementation status of the work.

The AR content generation unit 12 acquires the current time from any one of a built-in clock or an external clock.

The AR content generation unit 12 stores a time at which an operator has started the work.

As the implementation time of the work, the AR content generation unit 12 calculates the time from the time at which the operator has started the work until the current time.

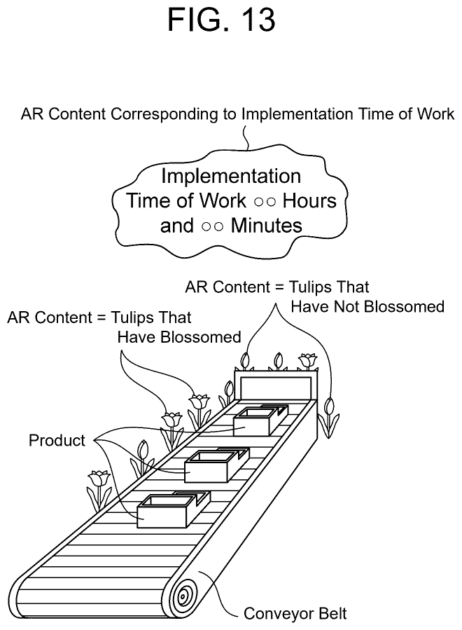

For example, as illustrated in FIG. 13, the AR content generation unit 12 generates the AR content corresponding to the implementation time of the work.

FIG. 13 is an explanatory diagram illustrating an example of the AR content corresponding to the implementation time of work.

The display data output unit 13 acquires the sensing data from the sensing data acquisition unit 11.

In addition, the display data output unit 13 acquires, from the AR content generation unit 12, each of the AR content corresponding to the implementation status of the work and the AR content corresponding to the implementation time of the work.

The display data output unit 13 overlays the display data representing each of the types of AR content on the captured-image data, which is the sensing data.

When overlaying the display data on the captured-image data, the display data output unit 13 overlays the display data on the captured-image data in such a manner that the implementation status of the work performed by the operator is not hidden by each of the types of AR content.

That is, as illustrated in FIG. 13, the display data output unit 13 overlays the display data on the captured-image data in such a manner that products being conveyed by the conveyor belt are not hidden by the AR content.

The display data output unit 13 outputs the captured-image data after the overlay of the display data to a display device 3.

The display device 3 acquires the captured-image data after the overlay of the display data from the display data output unit 13 of the work support device 2.

The display device 3 displays the AR content on the basis of the captured-image data after the overlay of the display data.

Thereby, for example, the AR content illustrated in FIG. 13 is displayed on the display device 3.

In the fourth embodiment mentioned above, the work support device 2 is configured in such a manner that the AR content generation unit 12 generates the AR content corresponding to the implementation status of the work and additionally generates the AR content corresponding to the implementation time of the work. Accordingly, the work support device 2 allows the operator to check the implementation status of the work and additionally allows the operator to check the implementation time of the work.

### Fifth Embodiment

In a work support device 2 explained in a fifth embodiment, an AR content generation unit 12 generates AR content corresponding to the implementation status of work and additionally generates AR content corresponding to the current weather.

The configuration of the work support device 2 according to the fifth embodiment is similar to the configuration of the work support device 2 according to the first embodiment, and the configuration diagram illustrating a work support system including the work support device 2 according to the fifth embodiment is FIG. 1.

The AR content generation unit 12 generates the AR content corresponding to the implementation status of the work and additionally generates the AR content corresponding to the current weather.

The AR content generation unit 12 outputs, to a display data output unit 13, display data representing the AR content corresponding to the implementation status of the work and display data representing the AR content corresponding to the current weather.

Next, operations performed by the work support system according to the fifth embodiment are explained. It should be noted that the work support system according to the fifth embodiment is similar to the work support system illustrated in FIG. 1 except for the AR content generation unit 12. Because of this, here, operations performed by the AR content generation unit 12 are mainly explained.

The AR content generation unit 12 acquires sensing data from a sensing data acquisition unit 11.

Similarly to the first embodiment, on the basis of the sensing data, the AR content generation unit 12 generates the AR content corresponding to the implementation status of the work.

For example, the AR content generation unit 12 acquires weather information representing the current weather from an unillustrated weather site.

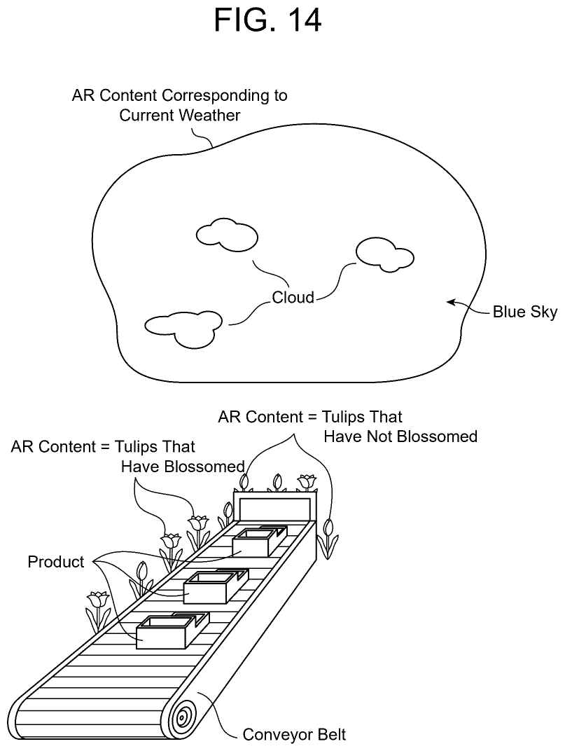

For example, as illustrated in FIG. 14, the AR content generation unit 12 generates the AR content corresponding to the weather represented by the weather information.

FIG. 14 is an explanatory diagram illustrating an example of the AR content corresponding to the current weather.

In the example in FIG. 14, as the background of the conveyor belt or the like, the AR content corresponding to the current weather is displayed. In the example in FIG. 14, the current weather is illustrated as being weather in which clouds are present in a part of the blue sky.

The display data output unit 13 acquires the sensing data from the sensing data acquisition unit 11.

In addition, the display data output unit 13 acquires, from the AR content generation unit 12, each of the AR content corresponding to the implementation status of the work and the AR content corresponding to the current weather.

The display data output unit 13 overlays the display data representing each of the types of AR content on the captured-image data, which is the sensing data.

When overlaying the display data on the captured-image data, the display data output unit 13 overlays the display data on the captured-image data in such a manner that the implementation status of the work performed by an operator is not hidden by each of the types of AR content.

That is, as illustrated in FIG. 14, the display data output unit 13 overlays the display data on the captured-image data in such a manner that products being conveyed by the conveyor belt are not hidden by the AR content.

The display data output unit 13 outputs the captured-image data after the overlay of the display data to a display device 3.

The display device 3 acquires the captured-image data after the overlay of the display data from the display data output unit 13 of the work support device 2.

The display device 3 displays the AR content on the basis of the captured-image data after the overlay of the display data.

Thereby, for example, the AR content illustrated in FIG. 14 is displayed on the display device 3.

In the fifth embodiment mentioned above, the work support device 2 is configured in such a manner that the AR content generation unit 12 generates the AR content corresponding to the implementation status of the work and additionally generates the AR content corresponding to the current weather. Accordingly, the work support device 2 allows the operator to check the implementation status of the work and additionally allows the operator to check the current weather.

### Sixth Embodiment

In a work support device 2 explained in a sixth embodiment, an AR content generation unit 12 generates AR content corresponding to the implementation status of work and additionally generates AR content corresponding to the cleaning status in the facility where the work is being performed.

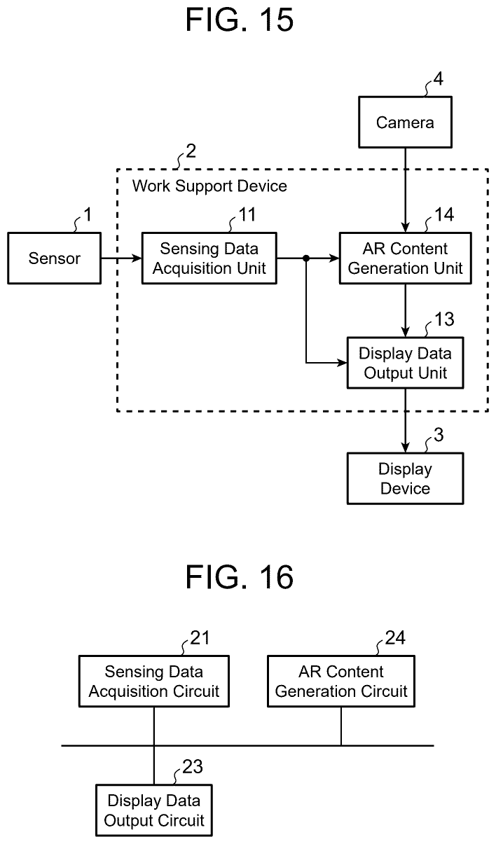

FIG. 15 is a configuration diagram illustrating a work support system including the work support device 2 according to the sixth embodiment. Reference signs in FIG. 15 that are identical to those in FIG. 1 denote identical or equivalent portions. Accordingly, detailed explanation thereof is omitted.

FIG. 16 is a hardware configuration diagram illustrating the hardware of the work support device 2 according to the sixth embodiment. Reference signs in FIG. 16 that are identical to those in FIG. 2 denote identical or equivalent portions. Accordingly, detailed explanation thereof is omitted.

The work support system illustrated in FIG. 15 includes a sensor 1, a camera 4, the work support device 2, and a display device 3.

The camera 4 captures an image in the facility where the work is being performed and outputs data of the image captured in the facility to the work support device 2. For example, examples of image-capturing locations in the facility include the vicinity of the conveyor belt and the exit/entrance of the facility.

For example, an AR content generation unit 14 is implemented by an AR content generation circuit 24 illustrated in FIG. 16.

The AR content generation unit 14 acquires sensing data from a sensing data acquisition unit 11 and acquires the data of the image captured in the facility from the camera 4.

Similarly to the AR content generation unit 12 illustrated in FIG. 1, on the basis of the sensing data, the AR content generation unit 14 generates the AR content corresponding to the implementation status of the work.

On the basis of the data of the image captured in the facility, the AR content generation unit 14 determines whether or not garbage has accumulated in the facility.

The AR content generation unit 14 generates the AR content corresponding to the cleaning status in the facility where the work is being performed.

Specifically, when garbage has accumulated in the facility, the AR content generation unit 14 generates AR content representing that garbage has accumulated as the cleaning status in the facility where the work is being performed.

The AR content generation unit 14 outputs, to a display data output unit 13, display data representing the AR content corresponding to the implementation status of the work and display data representing the AR content corresponding to the cleaning status in the facility.

It is assumed in FIG. 15 that each of the sensing data acquisition unit 11, the AR content generation unit 14, and the display data output unit 13, which are constituent elements of the work support device 2, is implemented by dedicated hardware illustrated in FIG. 16. That is, it is assumed that the work support device 2 is implemented by a sensing data acquisition circuit 21, the AR content generation circuit 24, and a display data output circuit 23.

For example, each of the sensing data acquisition circuit 21, the AR content generation circuit 24, and the display data output circuit 23 corresponds to a single circuit, a composite circuit, a programmed processor, a parallel-programmed processor, an ASIC, an FPGA, or a combination of these.

The constituent elements of the work support device 2 are not limited to those implemented by dedicated hardware, but the work support device 2 may be implemented by software, firmware, or a combination of software and firmware.

In a case where the work support device 2 is implemented by software, firmware, or the like, a program for causing a computer to execute a processing procedure performed at each of the sensing data acquisition unit 11, the AR content generation unit 14, and the display data output unit 13 is stored in a memory 31 illustrated in FIG. 3. Then, a processor 32 illustrated in FIG. 3 executes the programs stored in the memory 31.

In addition, FIG. 16 illustrates an example in which each of the constituent elements of the work support device 2 is implemented by dedicated hardware, and FIG. 3 illustrates an example in which the work support device 2 is implemented by software, firmware, or the like. However, this is merely an example. Some constituent elements of the work support device 2 may be implemented by dedicated hardware, and the remaining constituent elements may be implemented by software, firmware, or the like.

Next, operations performed by the work support system illustrated in FIG. 15 are explained. It should be noted that the work support system according to the sixth embodiment is similar to the work support system illustrated in FIG. 1 except for the camera 4 and the AR content generation unit 14. Because of this, here, operations performed by the camera 4 and the AR content generation unit 14 are mainly explained.

The camera 4 captures an image in the facility where the work is being performed and outputs data of the image captured in the facility to the work support device 2.

The AR content generation unit 14 acquires the sensing data from the sensing data acquisition unit 11.

Similarly to the AR content generation unit 12 illustrated in FIG. 1, on the basis of the sensing data, the AR content generation unit 14 generates the AR content corresponding to the implementation status of the work.

The AR content generation unit 14 acquires the data of the image captured in the facility from the camera 4.

On the basis of the data of the image captured in the facility, the AR content generation unit 14 determines whether or not garbage has accumulated in the facility.

Hereinbelow, a determination process performed by the AR content generation unit 14 is explained specifically.

As the data of the image captured in the facility, the AR content generation unit 14 acquires data of an image captured around the conveyor belt from the camera 4, for example.

An image representing the vicinity of the conveyor belt when garbage has not accumulated around the conveyor belt is stored in an internal memory of the AR content generation unit 14 or the like.

The AR content generation unit 14 compares the image represented by the data of the image captured around the conveyor belt and the image representing the vicinity of the conveyor belt when garbage has not accumulated.

When the similarity between both images is equal to or greater than a threshold, the AR content generation unit 14 determines that garbage has not accumulated around the conveyor belt.

When the similarity between both images is lower than the threshold, the AR content generation unit 14 determines that garbage has accumulated around the conveyor belt. The threshold may be stored in the internal memory of the AR content generation unit 14 or may be given from the outside of the work support device 2.

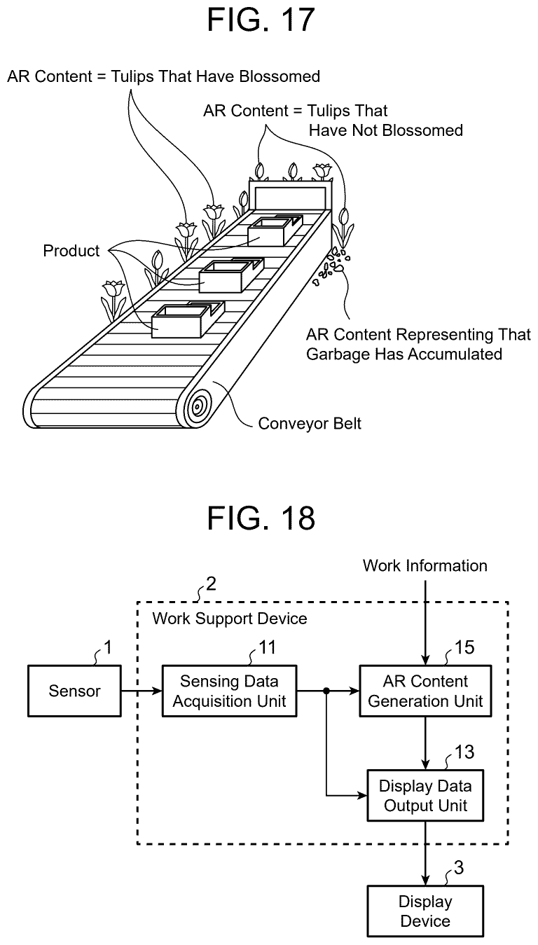

When garbage has accumulated in the facility, the AR content generation unit 14 generates AR content representing that garbage has accumulated as the cleaning status in the facility where the work is being performed, as illustrated in FIG. 17, for example. Since the process of generating AR content representing that garbage has accumulated itself is a known technology, detailed explanation thereof is omitted.

FIG. 17 is an explanatory diagram illustrating an example of the AR content representing that garbage has accumulated.

When garbage has not accumulated in the facility, the AR content generation unit 14 generates AR content representing that garbage has not accumulated as the cleaning status in the facility where the work is being performed. For example, examples of the AR content representing that garbage has not accumulated include a message that “no garbage.”

It is assumed here that the AR content generation unit 14 generates AR content representing that garbage has not accumulated. However, this is merely an example. When garbage has not accumulated in the facility, the AR content generation unit 14 may not generate the AR content corresponding to the cleaning status in the facility.

The AR content generation unit 14 outputs the display data representing the AR content corresponding to the implementation status of the work to the display data output unit 13.

When the AR content generation unit 14 has generated the AR content corresponding to the cleaning status in the facility, the AR content generation unit 14 outputs display data representing the AR content to the display data output unit 13.

The display data output unit 13 acquires the sensing data from the sensing data acquisition unit 11.

In addition, the display data output unit 13 acquires the AR content corresponding to the implementation status of the work from the AR content generation unit 14. When the AR content corresponding to the cleaning status in the facility is output from the AR content generation unit 14, the display data output unit 13 acquires the AR content.

The display data output unit 13 overlays the display data representing each of the types of AR content on the captured-image data, which is the sensing data.

When overlaying the display data on the captured-image data, the display data output unit 13 overlays the display data on the captured-image data in such a manner that the implementation status of the work performed by an operator is not hidden by each of the types of AR content.

That is, as illustrated in FIG. 17, the display data output unit 13 overlays the display data on the captured-image data in such a manner that products being conveyed by the conveyor belt are not hidden by the AR content.

The display data output unit 13 outputs the captured-image data after the overlay of the display data to the display device 3.

The display device 3 acquires the captured-image data after the overlay of the display data from the display data output unit 13 of the work support device 2.

The display device 3 displays the AR content on the basis of the captured-image data after the overlay of the display data.

Thereby, for example, the AR content illustrated in FIG. 17 is displayed on the display device 3.

The work support device 2 in the sixth embodiment mentioned above is configured in such a manner that the AR content generation unit 12 generates the AR content corresponding to the implementation status of the work and additionally generates the AR content corresponding to the cleaning status in the facility where the work is being performed. Accordingly, the work support device 2 allows the operator to check the implementation status of the work and additionally allows the operator to check the cleaning status in the facility.

### Seventh Embodiment

In a work support device 2 explained in a seventh embodiment, an AR content generation unit 15 generates AR content corresponding to the implementation status of work and additionally generates AR content representing a mascot character who guides the implementation content of the work.

FIG. 18 is a configuration diagram illustrating a work support system including the work support device 2 according to the seventh embodiment. Reference signs in FIG. 18 that are identical to those in FIGS. 1 and 15 denote identical or equivalent portions. Accordingly, detailed explanation thereof is omitted.

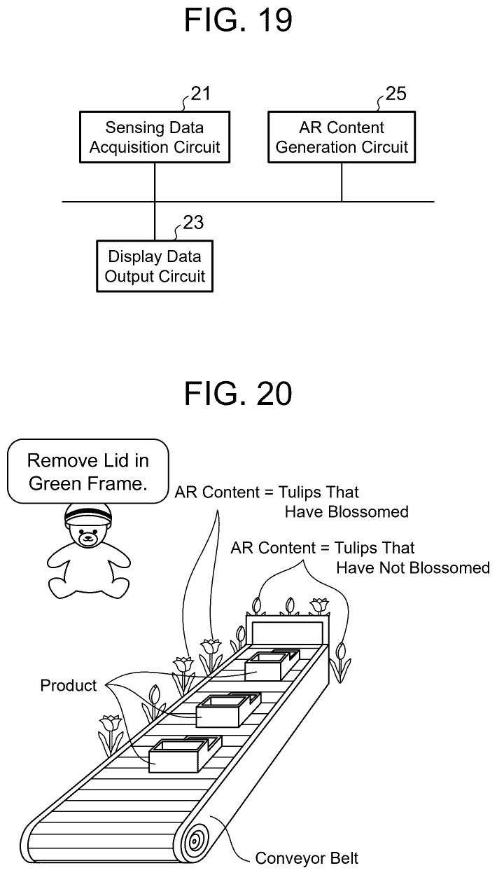

FIG. 19 is a hardware configuration diagram illustrating the hardware of the work support device 2 according to the seventh embodiment. Reference signs in FIG. 19 that are identical to those in FIGS. 2 and 16 denote identical or equivalent portions. Accordingly, detailed explanation thereof is omitted.

For example, the AR content generation unit 15 is implemented by an AR content generation circuit 25 illustrated in FIG. 19.

The AR content generation unit 15 acquires sensing data from a sensing data acquisition unit 11 and acquires work information representing the implementation content of the work.

Similarly to the AR content generation unit 12 illustrated in FIG. 1, on the basis of the sensing data, the AR content generation unit 15 generates the AR content corresponding to the implementation status of the work.

On the basis of the work information, the AR content generation unit 15 grasps the implementation content of the work performed by an operator.

The AR content generation unit 15 generates the AR content representing the mascot character who guides the implementation content of the work.

The AR content generation unit 15 outputs, to a display data output unit 13, display data representing the AR content corresponding to the implementation status of the work and display data of the AR content representing the mascot character.

The work support device 2 illustrated in FIG. 18 is obtained by applying the AR content generation unit 15 to the work support device 2 illustrated in FIG. 1. However, this is merely an example. The work support device 2 illustrated in FIG. 18 may be obtained by applying the AR content generation unit 15 to the work support device 2 illustrated in FIG. 15.

It is assumed in FIG. 18 that each of the sensing data acquisition unit 11, the AR content generation unit 15, and the display data output unit 13, which are constituent elements of the work support device 2, is implemented by dedicated hardware illustrated in FIG. 19. That is, it is assumed that the work support device 2 is implemented by a sensing data acquisition circuit 21, the AR content generation circuit 25, and a display data output circuit 23.

For example, each of the sensing data acquisition circuit 21, the AR content generation circuit 25, and the display data output circuit 23 corresponds to a single circuit, a composite circuit, a programmed processor, a parallel-programmed processor, an ASIC, an FPGA, or a combination of these.

The constituent elements of the work support device 2 are not limited to those implemented by dedicated hardware, but the work support device 2 may be implemented by software, firmware, or a combination of software and firmware.

In a case where the work support device 2 is implemented by software, firmware, or the like, a program for causing a computer to execute a processing procedure performed at each of the sensing data acquisition unit 11, the AR content generation unit 15, and the display data output unit 13 is stored in a memory 31 illustrated in FIG. 3. Then, a processor 32 illustrated in FIG. 3 executes the programs stored in the memory 31.

In addition, FIG. 19 illustrates an example in which each of the constituent elements of the work support device 2 is implemented by dedicated hardware, and FIG. 3 illustrates an example in which the work support device 2 is implemented by software, firmware, or the like. However, this is merely an example. Some constituent elements of the work support device 2 may be implemented by dedicated hardware, and the remaining constituent elements may be implemented by software, firmware, or the like.

Next, operations performed by the work support system illustrated in FIG. 18 are explained. It should be noted that the work support system according to the seventh embodiment is similar to the work support system illustrated in FIG. 1 except for the AR content generation unit 15. Because of this, here, operations performed by the AR content generation unit 15 are mainly explained.

The AR content generation unit 15 acquires the sensing data from the sensing data acquisition unit 11 and acquires the work information representing the implementation content of the work.

Similarly to the AR content generation unit 12 illustrated in FIG. 1, on the basis of the sensing data, the AR content generation unit 15 generates the AR content corresponding to the implementation status of the work.

On the basis of the work information, the AR content generation unit 15 grasps the implementation content of the work performed by the operator.

As illustrated in FIG. 20, the AR content generation unit 15 generates the AR content representing the mascot character who guides the implementation content of the work.

FIG. 20 is an explanatory diagram illustrating an example of the AR content representing the mascot character who guides the implementation content of the work.

FIG. 20 illustrates an example in which the implementation content of the work is “remove lid in green frame.”

The AR content generation unit 15 outputs, to the display data output unit 13, display data representing the AR content corresponding to the implementation status of the work and display data of the AR content representing the mascot character.

The display data output unit 13 acquires the sensing data from the sensing data acquisition unit 11.

In addition, the display data output unit 13 acquires, from the AR content generation unit 15, each of the AR content corresponding to the implementation status of the work and the AR content representing the mascot character.

The display data output unit 13 overlays the display data representing each of the types of AR content on the captured-image data, which is the sensing data.

When overlaying the display data on the captured-image data, the display data output unit 13 overlays the display data on the captured-image data in such a manner that the implementation status of the work performed by the operator is not hidden by each of the types of AR content.

That is, as illustrated in FIG. 20, the display data output unit 13 overlays the display data on the captured-image data in such a manner that products being conveyed by the conveyor belt are not hidden by the AR content.

The display data output unit 13 outputs the captured-image data after the overlay of the display data to a display device 3.

The display device 3 acquires the captured-image data after the overlay of the display data from the display data output unit 13 of the work support device 2.

The display device 3 displays the AR content on the basis of the captured-image data after the overlay of the display data.

Thereby, for example, the AR content illustrated in FIG. 20 is displayed on the display device 3.

In the seventh embodiment mentioned above, the work support device 2 is configured in such a manner that the AR content generation unit 15 generates the AR content corresponding to the implementation status of the work and additionally generates the AR content representing the mascot character who guides the implementation content of the work. Accordingly, the work support device 2 allows the operator to check the implementation status of the work and additionally allows the operator to check the implementation content of the work.

In the work support device 2 illustrated in FIG. 18, the AR content generation unit 15 generates the AR content representing the mascot character who guides the implementation content of the work. At this time, the AR content generation unit 15 may adjust the speed of work represented by implementation content guided by the mascot character, depending on any one of the skill of the operator or the physical condition of the operator.

Specifically, for example, assuming that the implementation content of the work is “work of tightening a screw,” the AR content generation unit 15 adjusts the work speed of the “work of tightening a screw,” which is implementation content, depending on any one of the skill of the operator or the physical condition of the operator. That is, as implementation content in which the work speed of tightening a screw is increased as the skill of the operator increases, the AR content generation unit 15 determines a guidance “tighten screw in ◯◯ seconds,” for example. In addition, as implementation content in which the work speed of tightening a screw is lowered when the physical condition of the operator is not good, the AR content generation unit 15 determines a guidance “tighten a screw in approximately Δ minutes,” for example.

For example, the AR content generation unit 15 gives an unillustrated learning model any one of the skill of the operator or the physical condition of the operator to acquire speed information representing a work speed corresponding to any one of the skill of the operator or the physical condition of the operator from the learning model.

By being given any one of the skill of the operator or the physical condition of the operator and training data representing the work speed at the time of training, the learning model has learned the work speed corresponding to any one of the skill of the operator or the physical condition of the operator.

The AR content generation unit 15 generates the AR content representing the mascot character who guides the implementation content for implementing the work at a work speed represented by speed information.

In the work support device 2 illustrated in FIG. 18, the AR content generation unit 15 generates AR content representing a mascot character based on a bear as the AR content representing the mascot character who guides the implementation content of the work. However, this is merely an example. Before generating the AR content representing the mascot character who guides the implementation content of the work, the AR content generation unit 15 may accept selection of AR content representing a to-be-generated mascot character.

Specifically, for example, the AR content generation unit 15 includes a user interface, and, when a user operates the user interface to thereby select AR content representing a to-be-generated mascot character, the AR content generation unit 15 generates the AR content representing the mascot character.

### Eighth Embodiment

In a work support device 2 explained in an eighth embodiment, an AR content generation unit 16 generates AR content corresponding to the implementation status of work and additionally generates AR content representing operations performed by a skilled worker for the work.

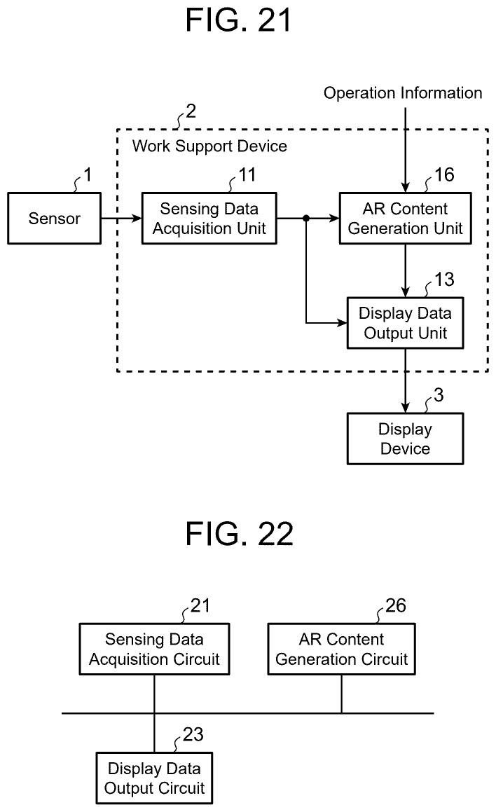

FIG. 21 is a configuration diagram illustrating a work support system including the work support device 2 according to the eighth embodiment. Reference signs in FIG. 21 that are identical to those in FIGS. 1, 15 and 18 denote identical or equivalent portions. Accordingly, detailed explanation thereof is omitted.

FIG. 22 is a hardware configuration diagram illustrating the hardware of the work support device 2 according to the eighth embodiment. Reference signs in FIG. 22 that are identical to those in FIGS. 2, 16, and 19 denote identical or equivalent portions. Accordingly, detailed explanation thereof is omitted.

For example, the AR content generation unit 16 is implemented by an AR content generation circuit 26 illustrated in FIG. 22.

The AR content generation unit 16 acquires sensing data from a sensing data acquisition unit 11 and acquires operation information representing the operations performed by the skilled worker for work performed by an operator.

Similarly to the AR content generation unit 12 illustrated in FIG. 1, on the basis of the sensing data, the AR content generation unit 16 generates the AR content corresponding to the implementation status of the work.

On the basis of the operation information, the AR content generation unit 16 grasps the operations performed by the skilled worker.

The AR content generation unit 16 generates AR content representing the operations performed by the skilled worker.

The AR content generation unit 16 outputs, to a display data output unit 13, display data representing the AR content corresponding to the implementation status of the work and display data of the AR content representing the operations performed by the skilled worker.

The work support device 2 illustrated in FIG. 21 is obtained by applying the AR content generation unit 16 to the work support device 2 illustrated in FIG. 1. However, this is merely an example. The work support device 2 illustrated in FIG. 21 may be obtained by applying the AR content generation unit 16 to the work support device 2 illustrated in FIG. 15 or the work support device 2 illustrated in FIG. 18.

It is assumed in FIG. 21 that each of the sensing data acquisition unit 11, the AR content generation unit 16, and the display data output unit 13, which are constituent elements of the work support device 2, is implemented by dedicated hardware illustrated in FIG. 22. That is, it is assumed that the work support device 2 is implemented by a sensing data acquisition circuit 21, the AR content generation circuit 26, and a display data output circuit 23.

For example, each of the sensing data acquisition circuit 21, the AR content generation circuit 26, and the display data output circuit 23 corresponds to a single circuit, a composite circuit, a programmed processor, a parallel-programmed processor, an ASIC, an FPGA, or a combination of these.

The constituent elements of the work support device 2 are not limited to those implemented by dedicated hardware, but the work support device 2 may be implemented by software, firmware, or a combination of software and firmware.

In a case where the work support device 2 is implemented by software, firmware, or the like, a program for causing a computer to execute a processing procedure performed at each of the sensing data acquisition unit 11, the AR content generation unit 16, and the display data output unit 13 is stored in a memory 31 illustrated in FIG. 3. Then, a processor 32 illustrated in FIG. 3 executes the programs stored in the memory 31.

In addition, FIG. 22 illustrates an example in which each of the constituent elements of the work support device 2 is implemented by dedicated hardware, and FIG. 3 illustrates an example in which the work support device 2 is implemented by software, firmware, or the like. However, this is merely an example. Some constituent elements of the work support device 2 may be implemented by dedicated hardware, and the remaining constituent elements may be implemented by software, firmware, or the like.

Next, operations performed by the work support system illustrated in FIG. 21 are explained. It should be noted that the work support system according to the eighth embodiment is similar to the work support system illustrated in FIG. 1 except for the AR content generation unit 16. Because of this, here, operations performed by the AR content generation unit 16 are mainly explained.

The AR content generation unit 16 acquires the sensing data from the sensing data acquisition unit 11 and acquires operation information representing the operations performed by the skilled worker for work performed by the operator.

For example, examples of the operations performed by the skilled worker include a line of flow at the time of work performed by the skilled worker and the way of physical movement at the time of work performed by the skilled worker.

Similarly to the AR content generation unit 12 illustrated in FIG. 1, on the basis of the sensing data, the AR content generation unit 16 generates the AR content corresponding to the implementation status of the work.

On the basis of the operation information, the AR content generation unit 16 grasps the operations performed by the skilled worker. For example, when the operation information represents a line of flow at the time of work performed by the skilled worker, the AR content generation unit 16 grasps the line of flow at the time of the work. For example, when the operation information represents the way of physical movement at the time of the work, the AR content generation unit 16 grasps the way of physical movement at the time of work.

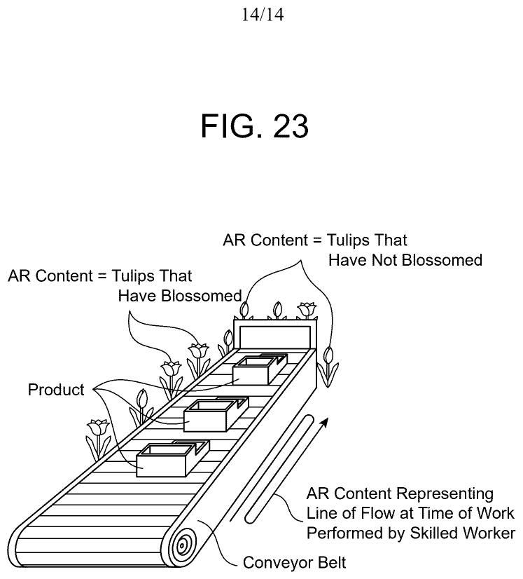

As illustrated in FIG. 23, the AR content generation unit 16 generates the AR content representing the operations performed by the skilled worker.

FIG. 23 is an explanatory diagram illustrating an example of the AR content representing the operations performed by the skilled worker.

FIG. 23 displays AR content representing a line of flow at the time of work performed by a skilled worker as AR content representing the operations performed by the skilled worker.

The AR content generation unit 16 outputs, to the display data output unit 13, display data representing the AR content corresponding to the implementation status of the work and display data of the AR content representing the operations performed by the skilled worker.

The display data output unit 13 acquires the sensing data from the sensing data acquisition unit 11.

In addition, the display data output unit 13 acquires, from the AR content generation unit 16, each of the AR content corresponding to the implementation status of the work and the AR content representing the operations performed by the skilled worker.

The display data output unit 13 overlays the display data representing each of the types of AR content on the captured-image data, which is the sensing data.

When overlaying the display data on the captured-image data, the display data output unit 13 overlays the display data on the captured-image data in such a manner that the implementation status of the work performed by the operator is not hidden by each of the types of AR content.

That is, as illustrated in FIG. 23, the display data output unit 13 overlays the display data on the captured-image data in such a manner that products being conveyed by the conveyor belt are not hidden by the AR content.

The display data output unit 13 outputs the captured-image data after the overlay of the display data to a display device 3.

The display device 3 acquires the captured-image data after the overlay of the display data from the display data output unit 13 of the work support device 2.

The display device 3 displays the AR content on the basis of the captured-image data after the overlay of the display data.

Thereby, for example, the AR content illustrated in FIG. 23 is displayed on the display device 3.

In the eighth embodiment mentioned above, the work support device 2 is configured in such a manner that the AR content generation unit 16 generates the AR content corresponding to the implementation status of the work and additionally generates the AR content representing the operations performed by the skilled worker for the work. Accordingly, the work support device 2 allows the operator to check the implementation status of the work and additionally allows the operator to check the operations performed by the skilled worker.

Note that the present disclosure allows any combinations of embodiments, modifications of any constituent elements in embodiments, or omissions of any constituent elements in embodiments.

### INDUSTRIAL APPLICABILITY

The present disclosure is suited for a work support device, a work support method, and a work support system.

### REFERENCE SIGNS LIST

1: sensor; 2: work support device; 3: display device; 4: camera; 11: sensing data acquisition unit; 12, 14, 15, 16: AR content generation unit; 13: display data output unit; 21: sensing data acquisition circuit; 22, 24, 25, 26: AR content generation circuit; 23: display data output circuit; 31: memory; 32: processor

1. A work support device comprising processing circuitry
to acquire sensing data representing an implementation status of work performed by an operator from a sensor to monitor the implementation status of the work,
to generate AR content corresponding to the implementation status of the work on a basis of the sensing data acquired by the processing circuitry,
to output display data representing the AR content generated by the processing circuitry, and
to calculate an achievement rate of the work performed by the operator as the implementation status of the work on a basis of the sensing data acquired by the processing circuitry and generates the AR content corresponding to both a current season and the achievement rate of the work.

2. The work support device according to claim 1, wherein
the sensor is an image-capturing sensor to capture an image of the implementation status of the work,
the processing circuitry acquires, as the sensing data representing the implementation status of the work, captured-image data representing an image-capturing result of the image-capturing sensor, and
the processing circuitry overlays the display data representing the AR content generated by the processing circuitry on the captured-image data and outputs the captured-image data after the overlay of the display data.

3. The work support device according to claim 2, wherein the processing circuitry overlays the display data representing the AR content on the captured-image data in such a manner that the implementation status of the work performed by the operator is not hidden by the AR content generated by the processing circuitry.

4. The work support device according to claim 1, wherein the processing circuitry accepts selection of to-be-generated AR content before generating the AR content corresponding to the implementation status of the work.

5. The work support device according to claim 1, wherein the processing circuitry generates the AR content corresponding to the implementation status of the work and additionally generates the AR content corresponding to a current time.

6. The work support device according to claim 1, wherein the processing circuitry generates the AR content corresponding to the implementation status of the work and additionally generates the AR content corresponding to a current season.

7. The work support device according to claim 1, wherein the processing circuitry generates the AR content corresponding to the implementation status of the work and additionally generates the AR content corresponding to implementation time of the work.

8. The work support device according to claim 1, wherein the processing circuitry generates the AR content corresponding to the implementation status of the work and additionally generates the AR content corresponding to current weather.

9. The work support device according to claim 1, wherein the processing circuitry generates the AR content corresponding to the implementation status of the work and additionally generates the AR content corresponding to a cleaning status in a facility where the work is being performed.

10. The work support device according to claim 1, wherein the processing circuitry generates the AR content corresponding to the implementation status of the work and additionally generates the AR content representing a mascot character who guides implementation content of the work.

11. The work support device according to claim 10, wherein the processing circuitry adjusts a speed of work represented by the implementation content guided by the mascot character depending on any one of skill of the operator or physical condition of the operator.

12. The work support device according to claim 1, wherein the processing circuitry generates the AR content corresponding to the implementation status of the work and additionally generates the AR content representing an operation performed by a skilled worker for the work.

13. A work support method comprising:
acquiring sensing data representing an implementation status of work performed by an operator from a sensor to monitor the implementation status of the work;
generating AR content corresponding to the implementation status of the work on a basis of the sensing data;
outputting display data representing the AR content, and
calculating an achievement rate of the work performed by the operator as the implementation status of the work on a basis of the sensing data and generating the AR content corresponding to both a current season and the achievement rate of the work.

14. A work support system comprising processing circuitry
to monitor an implementation status of work performed by an operator,
to acquire sensing data representing the implementation status of the work from the sensor,
to generate AR content corresponding to the implementation status of the work on a basis of the sensing data,
to output display data representing the AR content,
to display the AR content on a basis of the display data, and
to calculate an achievement rate of the work performed by the operator as the implementation status of the work on a basis of the sensing data and generate the AR content corresponding to both a current season and the achievement rate of the work.
